(19) United States
(12) Patent Application Publication
(10) Pub. No.: US 2025/0159025 A1
(43) Pub. Date: May 15, 2025

(54) METHOD, APPARATUS AND COMPUTER PROGRAM

(71) Applicant: Nokia Technologies Oy, Espoo (FI)

(72) Inventors: Saurabh KHARE, Bangalore (IN); Rainer LIEBHART, Munich (DE); Alexander MILINSKI, Munich (DE)

(21) Appl. No.: 18/938,738

(22) Filed: Nov. 6, 2024

(30) Foreign Application Priority Data
Nov. 13, 2023 (IN) 202341077292

(51) Int. Cl. H04L 65/1069; H04L 65/1016

(52) U.S. Cl. CPC H04L 65/1069; H04L 65/1016

(57) ABSTRACT

There is provided a method performed by a home subscriber server or unified data management function, the method comprising: receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs; storing the received one or more IMS profiles; receiving, from a consumer network function, a second message comprising a discovery request indicating a target network function type as IMS AS and one or more target parameters; and sending, to the consumer network function, an IMS profile comprising one or more parameters matching the one or more target parameters.

### TECHNICAL FIELD

Various example embodiments of this disclosure relate to a method, apparatus, system and computer program and in particular but not exclusively to enabling (or otherwise facilitating) IMS AS discovery via a HSS or UDM.

### BACKGROUND

A communication network can be seen as a facility that enables communications between two or more communication devices or provides communication devices access to a data network. A mobile or wireless communication network is one example of a communication network. A communication device may be provided with a service by an application server.

Such communication networks operate in according with standards such as those provided by 3GPP (Third Generation Partnership Project) or ETSI (European Telecommunications Standards Institute). Examples of standards are the so-called 5G (5th Generation) standards provided by 3GPP.

In some communication networks, an internet protocol multimedia service (IMS) application server (AS) may be deployed. The IMS AS may provide an IMS Multimedia Telephony Service to devices within the network. This may, for example, enable different network capabilities and different types of devices (e.g., augmented reality (AR), virtual reality (VR), extended reality (XR) devices, robots, etc.) to be supported. As used herein, the services provided by an IMS AS may be referred to as “IMS services”.

### SUMMARY

Some example embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to an aspect, there is provided an apparatus comprising means for providing a home subscriber server or unified data management function configured to perform receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs; storing the received one or more IMS profiles; receiving, from a consumer network function, a second message comprising a discovery request indicating a target network function type as IMS AS and one or more target parameters; and sending, to the consumer network function, an IMS profile comprising one or more parameters matching the one or more target parameters.

The one or more parameters may comprise at least one of the following: information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services that can be exposed by the IMS AS.

The IMS AS identifying information may comprises at least one of the following: an IMS AS instance identifier or IMS AS set identifier; a session initiation protocol uniform resource identifier via which the IMS AS can be reached; or an IMS AS diameter address of the IMS AS.

The one or more IMS profiles may be stored at the home subscriber server or unified data management function and associated to one or more user identifiers.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The first message and/or second message may comprise one of: a diameter protocol message or a service based interface message.

The first message may be a diameter protocol message and may comprise a profile update request or a server assignment request.

The means may be for providing a home subscriber server or unified data management function further configured to perform: determining that no IMS profile comprising one or more parameters matching the one or more target parameters is stored at the home subscriber server or unified data management function; creating a subscription associated with the consumer network function based on the one or more target parameters; receiving a further IMS profile from an IMS AS, wherein the further IMS profile comprises one or more parameters matching the one or more target parameters; and sending a notification message to the consumer network function including the IMS profile comprising one or more parameters matching the one or more target parameters.

According to an aspect there is provided an apparatus comprising means for providing a consumer network function configured to perform: sending, to a home subscriber server or unified data management function, a second message comprising a discovery request indicating a target network function type as internet protocol multimedia subsystem application server, IMS AS, and one or more filter parameters defining one or more target parameters; receiving, from the home subscriber server or unified data management function, an IMS profile based on the one or more filter parameters; and connecting to the IMS AS based on the received IMS profile.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The received IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The IMS AS identifying information may comprise the IMS AS instance identifier or the IMS AS set identifier, and wherein means may be for providing a consumer network function further configured for: sending, to a network repository function, a third message comprising a further discovery request indicating the IMS AS instance identifier or IMS AS set identifier; receiving, from the network repository function, an IMS AS address based on the third message; and connecting to the IMS AS based on the received IMS AS address.

The further discovery request may further comprise at least one of the following: an indication that service exposure via a network exposure function is supported; information indicating the supported capabilities of the IMS AS; information identifying one or more users of the IMS AS; information identifying one or more groups of users of the IMS AS; or information indicating one or more user categories supported by the IMS AS.

The third message may comprise a diameter protocol request or a service based interface request.

According to an aspect there is provided an apparatus comprising means for providing an internet protocol multimedia subsystem application server, IMS AS, configured to perform: providing IMS services to one or more users or one or more groups of users; and sending, to a home subscriber server or unified data management function, a first message comprising an IMS profile of the IMS AS.

The first message may comprise one of: a diameter protocol message or a service based interface message.

The diameter protocol message may comprise a profile update request or a server assignment request.

The IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The means may be for providing an IMS AS further configured to perform: sending, to a network repository function, a registration message comprising at least one of the following: information indicating whether the IMS AS supports service exposure via a network exposure function; information indicating one or more IMS services provided by the IMS AS; information indicating one or more users for which the IMS AS supports IMS services; information indicating one or more groups of users for which the IMS AS supports IMS services;

information indicating one or more user categories for which the IMS AS supports IMS services; or information indicating one or more events and services exposed by the IMS AS.

According to an aspect, there is provided an apparatus comprising at least one processor and at least one memory storing instructions that, when executed by the at least one processor, cause the apparatus at least to: receive one or more internet protocol multimedia subsystem, IMS, profiles from one or more IMS application servers, IMS ASs, each IMS profile comprising IMS AS identifying information and one or more parameters of a respective IMS AS of the one or more IMS ASs; store the received one or more IMS profiles; receive, from a consumer network function, a second message comprising a discovery request indicating a target network function type as IMS AS and one or more target parameters; and send, to the consumer network function, an IMS profile comprising one or more parameters matching the one or more target parameters.

The one or more parameters may comprise at least one of the following: information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services that can be exposed by the IMS AS.

The IMS AS identifying information may comprises at least one of the following: an IMS AS instance identifier or IMS AS set identifier; a session initiation protocol uniform resource identifier via which the IMS AS can be reached; or an IMS AS diameter address of the IMS AS.

The one or more IMS profiles may be stored at the home subscriber server or unified data management function and associated to one or more user identifiers.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The first message and/or second message may comprise one of: a diameter protocol message or a service based interface message.

The first message may be a diameter protocol message and may comprise a profile update request or a server assignment request.

The instructions, when executed by the at least one processor, may further cause the apparatus to: determine that no IMS profile comprising one or more parameters matching the one or more target parameters is stored at the home subscriber server or unified data management function; create a subscription associated with the consumer network function based on the one or more target parameters; receive a further IMS profile from an IMS AS, wherein the further IMS profile comprises one or more parameters matching the one or more target parameters; and send a notification message to the consumer network function including the IMS profile comprising one or more parameters matching the one or more target parameters.

According to an aspect, there is provided an apparatus comprising at least one processor and at least one memory storing instructions that, when executed by the at least one processor, cause the apparatus at least to: send, to a home subscriber server or unified data management function, a second message comprising a discovery request indicating a target network function type as internet protocol multimedia subsystem application server, IMS AS, and one or more filter parameters defining one or more target parameters; receive, from the home subscriber server or unified data management function, an IMS profile based on the one or more filter parameters; and connect to the IMS AS based on the received IMS profile.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The received IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The IMS AS identifying information may comprise the IMS AS instance identifier or the IMS AS set identifier, and wherein means may be for providing a consumer network function further configured for: sending, to a network repository function, a third message comprising a further discovery request indicating the IMS AS instance identifier or IMS AS set identifier; receiving, from the network repository function, an IMS AS address based on the third message; and connecting to the IMS AS based on the received IMS AS address.

The further discovery request may further comprise at least one of the following: an indication that service exposure via a network exposure function is supported; information indicating the supported capabilities of the IMS AS; information identifying one or more users of the IMS AS;

information identifying one or more groups of users of the IMS AS; or information indicating one or more user categories supported by the IMS AS.

The third message may comprise a diameter protocol request or a service based interface request.

According to an aspect, there is provided an apparatus comprising at least one processor and at least one memory storing instructions that, when executed by the at least one processor, cause the apparatus at least to: provide IMS services to one or more users or one or more groups of users; and send, to a home subscriber server or unified data management function, a first message comprising an IMS profile of the IMS AS.

The first message may comprise one of: a diameter protocol message or a service based interface message.

The diameter protocol message may comprise a profile update request or a server assignment request.

The IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The instructions, when executed by the at least one processor, may further cause the apparatus to: send, to a network repository function, a registration message comprising at least one of the following: information indicating whether the IMS AS supports service exposure via a network exposure function; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

According to an aspect, there is provided a method performed by a home subscriber server or unified data management function, the method comprising: receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs; storing the received one or more IMS profiles; receiving, from a consumer network function, a second message comprising a discovery request indicating a target network function type as IMS AS and one or more target parameters; and sending, to the consumer network function, an IMS profile comprising one or more parameters matching the one or more target parameters.

The one or more parameters may comprise at least one of the following: information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services that can be exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The one or more IMS profiles may be stored at the home subscriber server or unified data management function and associated to one or more user identifiers.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The first message and/or second message may comprise one of: a diameter protocol message or a service based interface message.

The first message may be a diameter protocol message and may comprise a profile update request or a server assignment request.

The method may further comprise: determining that no IMS profile comprising one or more parameters matching the one or more target parameters is stored at the home subscriber server or unified data management function; creating a subscription associated with the consumer network function based on the one or more target parameters; receiving a further IMS profile from an IMS AS, wherein the further IMS profile comprises one or more parameters matching the one or more target parameters; and sending a notification message to the consumer network function including the IMS profile comprising one or more parameters matching the one or more target parameters.

According to an aspect there is provided a method performed by a consumer network function, the method comprising: sending, to a home subscriber server or unified data management function, a second message comprising a discovery request indicating a target network function type as internet protocol multimedia subsystem application server, IMS AS, and one or more filter parameters defining one or more target parameters; receiving, from the home subscriber server or unified data management function, an IMS profile based on the one or more filter parameters; and connecting to the IMS AS based on the received IMS profile.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The received IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The IMS AS identifying information may comprise the IMS AS instance identifier or the IMS AS set identifier, and wherein means may be for providing a consumer network function further configured for: sending, to a network repository function, a third message comprising a further discovery request indicating the IMS AS instance identifier or IMS AS set identifier; receiving, from the network repository function, an IMS AS address based on the third message; and connecting to the IMS AS based on the received IMS AS address.

The further discovery request may further comprise at least one of the following: an indication that service exposure via a network exposure function is supported; information indicating the supported capabilities of the IMS AS; information identifying one or more users of the IMS AS; information identifying one or more groups of users of the IMS AS; or information indicating one or more user categories supported by the IMS AS.

The third message may comprise a diameter protocol request or a service based interface request.

According to an aspect there is provided a method performed by an internet protocol multimedia subsystem application server, IMS AS, the method comprising: providing IMS services to one or more users or one or more groups of users; and sending, to a home subscriber server or unified data management function, a first message comprising an IMS profile of the IMS AS.

The first message may comprise one of: a diameter protocol message or a service based interface message.

The diameter protocol message may comprise a profile update request or a server assignment request.

The IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The method may further comprise: sending, to a network repository function, a registration message comprising at least one of the following: information indicating whether the IMS AS supports service exposure via a network exposure function; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

According to an aspect, there is provided a computer readable medium comprising instructions which, when executed by an apparatus, cause the apparatus to perform at least the following: receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs; storing the received one or more IMS profiles; receiving, from a consumer network function, a second message comprising a discovery request indicating a target network function type as IMS AS and one or more target parameters; and sending, to the consumer network function, an IMS profile comprising one or more parameters matching the one or more target parameters.

The one or more parameters may comprise at least one of the following: information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services that can be exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The one or more IMS profiles may be stored at the home subscriber server or unified data management function and associated to one or more user identifiers.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The first message and/or second message may comprise one of: a diameter protocol message or a service based interface message.

The first message may be a diameter protocol message and may comprise a profile update request or a server assignment request.

The instructions, when executed by the apparatus, may cause the apparatus to further perform: determining that no IMS profile comprising one or more parameters matching the one or more target parameters is stored at the home subscriber server or unified data management function; creating a subscription associated with the consumer network function based on the one or more target parameters; receiving a further IMS profile from an IMS AS, wherein the further IMS profile comprises one or more parameters matching the one or more target parameters; and sending a notification message to the consumer network function including the IMS profile comprising one or more parameters matching the one or more target parameters.

According to an aspect, there is provided a computer readable medium comprising instructions which, when executed by an apparatus, cause the apparatus to perform at least the following: sending, to a home subscriber server or unified data management function, a second message comprising a discovery request indicating a target network function type as internet protocol multimedia subsystem application server, IMS AS, and one or more filter parameters defining one or more target parameters; receiving, from the home subscriber server or unified data management function, an IMS profile based on the one or more filter parameters; and connecting to the IMS AS based on the received IMS profile.

The one or more target parameters may comprise at least one of the following: information indicating one or more target IMS services provided by an IMS AS; information indicating one or more target users for which an IMS AS supports IMS services; information indicating one or more target groups of users for which an IMS AS supports IMS services; or information indicating one or more target events and services exposed by an IMS AS.

The received IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; and information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The IMS AS identifying information may comprise the IMS AS instance identifier or the IMS AS set identifier, and wherein means may be for providing a consumer network function further configured for: sending, to a network repository function, a third message comprising a further discovery request indicating the IMS AS instance identifier or IMS AS set identifier; receiving, from the network repository function, an IMS AS address based on the third message; and connecting to the IMS AS based on the received IMS AS address.

The further discovery request may further comprise at least one of the following: an indication that service exposure via a network exposure function is supported; information indicating the supported capabilities of the IMS AS; information identifying one or more users of the IMS AS; information identifying one or more groups of users of the IMS AS; or information indicating one or more user categories supported by the IMS AS.

The third message may comprise a diameter protocol request or a service based interface request.

According to an aspect, there is provided a computer readable medium comprising instructions which, when executed by an apparatus, cause the apparatus to perform at least the following: providing IMS services to one or more users or one or more groups of users; and sending, to a home subscriber server or unified data management function, a first message comprising an IMS profile of the IMS AS.

The first message may comprise one of: a diameter protocol message or a service based interface message.

The diameter protocol message may comprise a profile update request or a server assignment request.

The IMS profile may comprise at least one of the following: IMS AS identifying information; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

The IMS AS identifying information may comprise at least one of the following: an IMS AS instance identifier or IMS AS set identifier; a session initiation protocol uniform resource identifier via which the IMS AS can be reached; or an IMS AS diameter address of the IMS AS.

The instructions, when executed by the apparatus, may cause the apparatus to further perform: sending, to a network repository function, a registration message comprising at least one of the following: information indicating whether the IMS AS supports service exposure via a network exposure function; information indicating one or more IMS services provided by the IMS AS; information indicating one or more users for which the IMS AS supports IMS services; information indicating one or more groups of users for which the IMS AS supports IMS services; information indicating one or more user categories for which the IMS AS supports IMS services; or information indicating one or more events and services exposed by the IMS AS.

According to an aspect, there is provided a non-transitory computer readable medium comprising program instructions that, when executed by an apparatus, cause the apparatus to perform at least the method according to any of the preceding aspects.

In the above, many different aspects have been described. It should be appreciated that further aspects may be provided by the combination of any two or more of the aspects described above.

### DESCRIPTION OF FIGURES

Some example embodiments will now be described, by way of non-limiting and illustrative example only, with reference to the accompanying Figures (FIGs.) in which:

FIG. 1 shows a representation of a 5th generation communication system;

FIG. 2 shows a representation of an apparatus for the communication system of FIG. 1 according to some example embodiments;

FIG. 3 shows a representation of an apparatus according to some example embodiments;

FIG. 4 shows an example network architecture including an IMS AS for providing AR functionality according to some example embodiments;

FIG. 5A, 5B, and 5C show methods according to some example embodiments;

FIG. 6 shows a signalling exchange according to some example embodiments; and

FIG. 7 shows a schematic representation of non-volatile memory media according to some example embodiments.

### DETAILED DESCRIPTION

A non-exhaustive list of some abbreviations used throughout the disclosure is provided below for reference:
AS—Application Server
DC—Data Channel
HSS—Home Subscriber Server
IMPI—IMS Private User Identity
IMPU—IMS Public User Identity
IMS—IP Multimedia Subsystem
MCC—Mission-Critical Communication
MMTel—Multimedia Telephony
NEF—Network Exposure Function
RCS—Rich Communication Services
SDP—Session Description Protocol
SIP—Session Initiation Protocol
UDM—Unified Data Management
UE—User Equipment

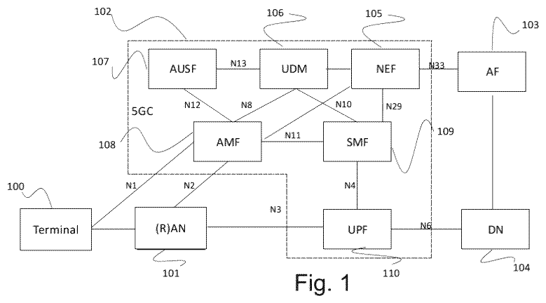

In the following, various example embodiments are explained with reference to communication devices capable of communication with a communication system. Before explaining in detail the various example embodiments of the methods and apparatuses of the disclosure, a 5th generation communication system (5GS), an access network and a core network (5GC) thereof, and communication devices are briefly explained with reference to FIGS. 1, 2 and 3.

FIG. 1 shows a schematic representation of a 5G communication system (5GS). The 5GS may comprise a user equipment (UE) or Terminal 100, an access network such as a 5G radio access network (5G-RAN) 101 or next generation radio access network (NG-RAN), a 5G core network 102, and one or more application functions 103. An application function 103 may be deployed in the 5GS as trusted application function or may be deployed or host on one or more application servers of the data network (DN) 104. Such application functions are untrusted application functions. The 5GS connects the UE to a data network the access network and the 5GC 102 (e.g., a UPF of the 5GC).

The 5G-RAN 101 may comprise one or more radio access nodes, such as gNodeB (gNB). A gNB may include one or more gNodeB (GNB) distributed units connected to one or more gNodeB (GNB) centralized units.

The 5GC may comprise the following network functions: Network Slice Selection Function (NSSF); Network Exposure Function (NEF) 105; Network Repository Function (NRF); Policy Control Function (PCF); Unified Data Management (UDM) 106; Application Function (AF) 103; Authentication Server Function (AUSF) 107; an Access and Mobility Management Function (AMF) 108; Session Management Function (SMF) 109; and a user plane function (UPF) 110. FIG. 1 also shows the various interfaces (N1, N2 etc.) that may be implemented between the various elements of the system.

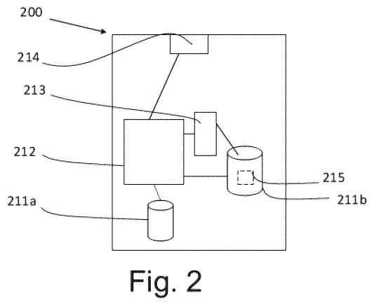

FIG. 2 illustrates an example of a control apparatus 200 for controlling a function of the access network (e.g., a 5G-RAN or the NG-RAN illustrated in FIG. 1) illustrated on FIG. 1. The control apparatus 200 may comprise at least one random access memory (RAM) 211a, at least on read only memory (ROM) 211b, at least one processor 212, 213 and a network interface 214. The at least one processor 212, 213 may be coupled to the RAM 211a and the ROM 211b. The at least one processor 212, 213 may be configured to execute an appropriate software code 215. Execution of the software code 215 may, for example, may cause the apparatus to perform operations for controlling a function of the access network. The software code 215 may be stored in the ROM 211b. The control apparatus 200 may be interconnected with another control apparatus 200 for controlling another function of the 5G-RAN or the NG-RAN. In some embodiments, each function of the 5G-RAN or the NG-RAN is deployed or hosted on a control apparatus 200. In alternative embodiments, two or more functions of the 5G-RAN or the NG-RAN may share a control apparatus.

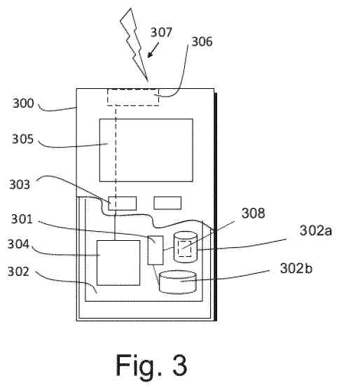

FIG. 3 illustrates an example of a communication device 300, such as the UE illustrated on FIG. 1. The communication device 300 may be provided by any device capable of sending and receiving radio signals. Non-limiting and illustrative examples of a communication device 300 comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The communication device 300 may comprise a transceiver for transmitting and/or receiving, for example, wireless signals carrying communications, for example radio signals. The communications may be one or more of voice, electronic mail (email), text messages, multimedia data, machine data and so on.

The communication device 300 may receive wireless signals (e.g., radio signals) over an air or radio interface 307 via appropriate apparatus for receiving and may transmit wireless signals via appropriate apparatus for transmitting radio signals. In FIG. 3 transceiver is designated schematically by block 306. The transceiver 306 may comprise, for example, a radio part and associated antenna arrangement. The antenna arrangement may be arranged internally or externally to the mobile device and may comprise one or more antenna elements. The antenna arrangement may be a multi-input multi output (MIMO) antenna.

The communication device 300 may be provided with at least one processor 301, at least one memory ROM 302a, at least one RAM 302b and other possible components 303 for use in software and hardware aided execution of tasks it is designed to perform, including control of access to and communications with access networks (e.g., the 5G-RAN or NG-RAN illustrated in FIG. 1) and other communication devices. The at least one processor 301 is coupled to the RAM 302b and the ROM 302a. The at least one processor 301 may be configured to execute an appropriate software code 308. The software code 308 may, for example, allow to perform one or more operations of the communication device. The software code 308 may be stored in the ROM 302a.

The processor, the ROM, and the RAM, the transceiver and other circuitry of the communication device (e.g., a modem) can be provided on a circuit board, in chipsets, or in a system on chip. The circuit board, chipsets or system on chip is denoted by reference 304. The communication device 300 may optionally have a user interface, such as keypad 305, touch sensitive screen or pad, combinations thereof or the like. Optionally one or more of a display, a speaker and a microphone may be provided depending on the type of communication device.

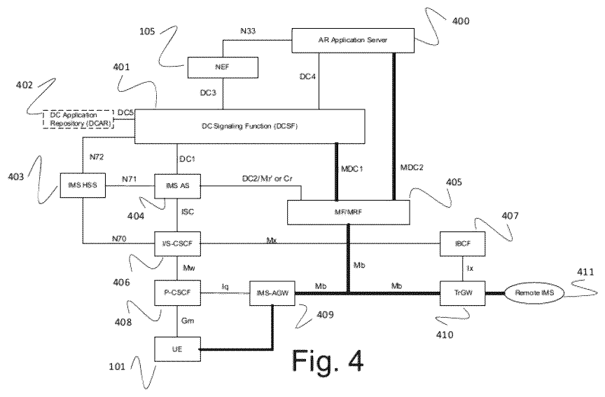

As explained above, an IMS AS may be deployed—in some examples—to provide IMS services to devices within a communications network. An example network architecture including an IMS AS for providing AR functionality according to some example embodiments is shown in FIG. 4.

The example architecture of FIG. 4 comprises an AR application server 400, network exposure function (NEF) 105, data channel signalling function (DCSF) 401, DC application repository (DCAR) 402, an (IMS) home subscriber server (HSS) 403, IMS AS 404, multimedia function (MF)/multimedia resource function (MRF) 405, interrogating/serving call session control function (I/S-CSCF) 406, interconnection border control function (IBCF) 407, proxy-CSCF (P-CSCF) 408, IMS application gateway (IMS-AGW) 409, transition gateway (TrGW) 410, remote IMS 411, and UE 101. Also shown are the various interfaces (e.g., N33, DC3, Mx, Mb, etc.) between the various network elements.

The AR AS 400 may be responsible for AR service control related to AR communication, including AR session media control, AR media capability negotiation with the UE 101. The MF/MRF 405 may support AR media processing and may receive and store AR service media handling logic from the AR AS 400 and provide Augmented Reality MF capability, based on the AR data received from UE 101. The IMS AS 404 may receive media control instructions from the DCSF 401 and interact with the UE 101 for connecting the UE's audio/video media termination to the MF.

One challenge with network deployments including an IMS AS 404 is in how IMS AS services may be exposed to consumer network functions within the network. Take for example, the following: how a consumer network function may determine the presence of an IMS AS 404, what services the IMS AS 40 404 can provide, an address of the IMS AS 404, what user(s) or group(s) of users are capable of being served by the IMS AS 404, etc. This may be important for the consumer network function to be able to discover the IMS AS 404 and subscribe to IMS services provided by the IMS AS 404.

One potential solution to this problem would be for the network exposure function (NEF) 105 to perform the service exposure. To do this, the NEF 105 would need to determine a serving IMS AS 404 for one or more IMS users. However, this is not possible according with network architectures according to existing standards, since the necessary information is known to the S-CSCF 406. Furthermore, the S-CSCF 406 may only have information about a session initiation protocol (SIP) address of the IMS AS 404, while further information (such as a http address) may—in certain use cases—be necessary for proper service exposure. While the S-CSCF information is known to the HSS 403, it is not known to the NEF 105, and so there is no direct way for the NEF 105 to discover a serving IMS AS 404 for a given user.

Some example of the disclosure provide mechanisms for enabling (or otherwise facilitating) IMS AS 404 discovery and service exposure. In some examples, a HSS 403 or UDM 106 stores an IMS profile of the IMS AS 404. In some examples, the HSS 403 or UDM 106 provides information to a consumer network function to enable (or otherwise facilitate) the consumer network function to discover an IMS AS 404 with particular characteristics (e.g., an IMS AS providing particular IMS services, providing IMS services to certain users, etc.) and connect to the discovered IMS AS.

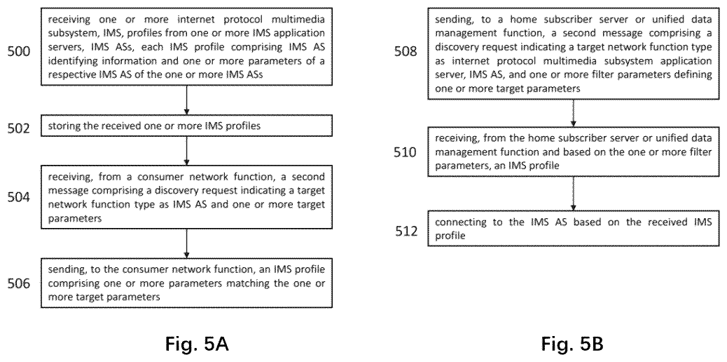

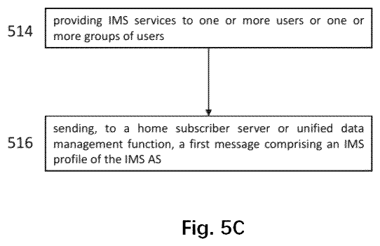

Reference is made to FIG. 5A, 5B, and 5C, which show methods according to some example embodiments.

FIG. 5A shows a method performed by a home subscriber server or unified data management function according to some examples. At 500, the method comprises receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs. At 502, the method comprises storing the received one or more IMS profiles. At 504, the method comprises receiving, from a consumer network function, a second message comprising a discovery request indicating a target network function type as IMS AS and one or more target parameters. At 506, the method comprises sending, to the consumer network function, an IMS profile comprising one or more parameters matching the one or more target parameters.

In some examples, the home subscriber server (HSS) or unified data management function (UDM) may receive a single IMS profile from a single IMS AS. In some examples, the home subscriber server (HSS) or unified data management function (UDM) may receive a plurality of IMS profiles (e.g., an initial IMS profile and an updated IMS profile) from a single IMS AS. In some examples, the home subscriber server (HSS) or unified data management function (UDM) may receive a plurality of IMS profiles (e.g., one IMS profile from each and any updates thereof) from a plurality of IMS ASs.

FIG. 5B shows a method performed by a consumer network function according to some examples. At 508, the method comprises sending, to a home subscriber server or unified data management function, a second message comprising a discovery request indicating a target network function type as internet protocol multimedia subsystem application server, IMS AS, and one or more filter parameters defining one or more target parameters. At 510, the method comprises receiving, from the home subscriber server or unified data management function, an IMS profile based on the one or more filter parameters. At 512, the method comprises connecting to the IMS AS based on the received IMS profile.

FIG. 5C shows a method performed by an internet protocol multimedia subsystem application server, IMS AS, according to some examples. At 514, the method comprises: providing IMS services to one or more users or one or more groups of users. At 516, the method comprises sending, to a home subscriber server or unified data management function, a first message comprising an IMS profile of the IMS AS.

While reference is made to an IMS AS in the disclosure, it should be understood that-in some examples-the IMS AS may be replaced by another network entity performing the same (or substantially the same) functions as the IMS AS. That is to say, in some examples, a network entity (which may be referred to as an IMS AS or otherwise) may perform the methods attributed to the IMS AS as disclosed herein.

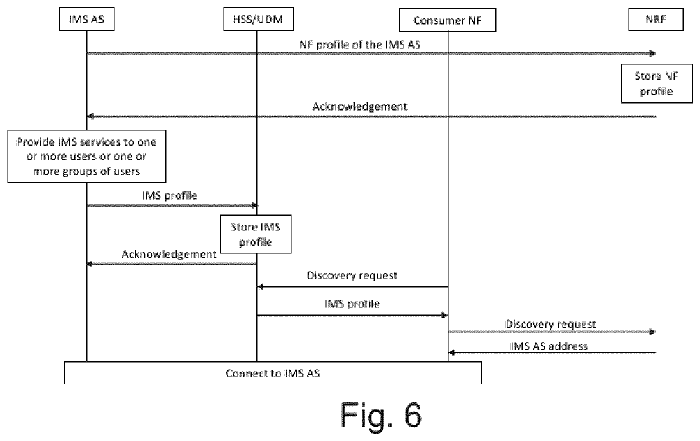

Reference is made to FIG. 6, which shows a signalling exchange according to some example embodiments.

At 600, the IMS AS 404 sends, to an NRF, a message comprising a NF profile of the IMS AS 404. The message may, for example, be an Nnrf_NFmanagement_Registration message. The NF profile may comprise one or more parameters defined in 3GPP TS 29.510, clause 6.1.6.2.2, and/or at least one of the following IMS AS parameters:
Information indicating whether the IMS AS 404 supports service exposure via the NEF 105. This may, for example, be a flag that is set when the IMS AS 404 supports service exposure via the NEF 105 and is not set when the IMS AS 404 does not support service exposure via the NEF 105;
Information indicating IMS services supported by the IMS AS 404—for example data channel (DC), multimedia telephony (MMTel), rich communications services (RCC), presence, mission critical communication (MCC), etc;
Information indicating one or more users for which the IMS AS 404 supports IMS services. This may, for example, be provided as an IMS public user identity (IMPU) or IMS private identity (IMPI);
Information indicating one or more groups of users for which the IMS AS 404 supports IMS services. This may, for example, be provided as IMPU/IMPI or wildcarded IMPU (e.g., an IMPU containing regular expressions, such as all IMPU starting with a certain sequence of numbers, such as “1234”) or a group identifier;
Information indicating one or more user categories for which the IMS AS 404 supports IMS services—for example whether the user is a normal user, a priority user, an enterprise user, etc; or
Information indicating one or more events supported by the IMS AS 404-for example CallEstablished, CallTerminated, PresenceService, RCSService etc.

At 602, the NRF stores the NF profile, based on the message received at 600. In some examples, the one or more IMS AS profiles may be stored at the HSS 403 or UDM 106 and associated to one or more user identifiers. The NRF may, at 604, send an acknowledgement to the IMS AS 404 indicating that the NF profile has been stored.

At 606, the IMS AS 404 begins providing IMS services to one or more users or one or more groups of users (e.g., one or more UEs, such as UE 101).

At 608, the IMS AS 404 registers with the HSS 403 or UDM 106. For example, the IMS AS 404 may send, to the HSS 403 or UDM 106, a first message comprising an IMS profile of the IMS AS 404.

The IMS profile may comprise IMS identifying information and one or more parameters. The one or more parameters may, for example, comprise at least one of the following: information indicating one or more IMS services provided by the IMS AS 404; information indicating one or more events or services exposed by the IMS AS 404; or information indicating a user identity of one or more users or a group identity of one or more groups of users or one or more user categories of users to which the IMS AS 404 is providing IMS services at 606, etc.

The IMS identifying information may comprise at least one of the following:
an IMS AS instance identifier or IMS AS set identifier;
a session initiation protocol (SIP) uniform resource identifier (URI) via which the IMS AS 404 can be reached; or.
an IMS AS diameter address of the IMS AS 404.

In some examples, the first message may comprise a diameter protocol message (e.g., a profile update request message, server assignment request message, or any other diameter protocol message may be used) or a service based interface (SBI) message (e.g., Nhss_imsUECM_registration message).

At 610, the HSS 403 or UDM 106 stores the received one or more IMS profiles. Optionally, the HSS 403 or UDM 106 may send an acknowledgement to the one or more IMS AS. The acknowledgement may, for example, be a PUR response message.

In some examples, the HSS 403 may receive the IMS profile(s) at 608 and store the IMS profile(s) at the HSS 403 at 610. In some examples, the UDM 106 may receive the IMS profile(s) at 608 and store the IMS profile(s) at the UDM 106 at 610. In some examples, the HSS 403 may receive the IMS profile(s) at 608 and store the IMS profile(s) at the UDM 106 at 610, wherein the HSS 403 is in communication with the UDM 106. For example, the HSS 403 may receive the IMS profile(s) at 608 and send a message to the UDM 106 comprising the received IMS profile(s), and the UDM 106 may store the received IMS profile(s).

While only one IMS AS 404 is shown in FIG. 6, it should be appreciated that—in some examples-there may be a plurality of IMS ASs. Each IMS AS may perform steps 600-610 as described previously. Therefore, in some examples, the HSS 403 or UDM 106 may receive an IMS profile from each of the plurality of IMS ASs. More generally, there may be one or more IMS ASs, and the HSS 403 or UDM 106 may receive an IMS profile from each of the one or more IMS ASs. That is to say, the HSS 403 or UDM 106 may receive and store one or more IMS profiles of one or more IMS ASs, where each IMS profile comprises IMS AS identifying information and one or more parameters of a respective IMS AS of the one or more IMS ASs.

At 612, a consumer network function sends, to the HSS 403 or UDM 106, a second message comprising a discovery request. The discovery request may indicate a target network function type as IMS AS and one or more target parameters.

The one or more target parameters may define parameters/characteristics of an IMS AS that the consumer network function wants to discover. For example, the one or more target parameters may comprise at least one of the following:
one or more target IMS services provided by an IMS AS-for example DC, MMTel, RCS, Presence, MCC, etc.;
one or more target users for which an IMS AS supports IMS services (e.g., IMPU or IMPI);
one or more target groups of users for which an IMS AS supports IMS services (e.g., IMPU/IMPI or wildcarded IMPU or a group identifier); or
one or more target events supported by an IMS AS (e.g., CallEstablished, CallTerminated, PresenceService, RCSService, MissionCriticalService, EmergencyService, etc.)

In some examples, the second message may comprise a diameter protocol message (e.g., a user-data request message) or a SBI message (e.g., Nhss_imsUECM_get message).

The consumer network function may be any network function, such as but not limited to a NEF 105, DCSF 401, etc.

At 614, the HSS 403 or UDM 106 sends, to the consumer network function, the IMS profile (received at 608 and stored at 610) comprising the one or more parameters matching the one or more target parameters defined in the second message (received at 612). That is to say, the HSS 403 or UDM 106 may send, to the consumer network function, the IMS profile (including the IMS AS identifying information) based on the stored IMS profile(s) of the IMS AS(s) and the second message.

In some examples, there may not be an IMS profile of an IMS AS that matches the one or more target parameters registered at the HSS 403 or UDM 106. For example, there may not be an IMS AS registered with the HSS 403 or UDM 106 that supports a certain target IMS service, or that is capable of providing an IMS service to a certain user or group of users. As a further example, there may not be an IMS subscriber registered at the HSS 403 or UDM 106 with a certain subscriber identifier.

In some examples, the consumer network function may subscribe at the HSS 403 or UDM 106 for an IMS profile that matches the one or more target parameters. Thus, when the HSS 403 or UDM 106 receives a further IMS profile that matches the one or more target parameters, the HSS 403 or UDM 106 may send the further IMS profile to the consumer network function at step 614 based on the subscription.

After step 614, the consumer network function may have received the IMS profile comprising the IMS identifying information of an IMS AS that meets the one or more target parameters set by the consumer network function.

As explained above, the IMS AS identifying information may comprise at least one of the following:
an IMS AS instance identifier or IMS AS set identifier;
a session initiation protocol (SIP) uniform resource identifier (URI) via which the IMS AS can be reached; or
an IMS AS diameter address of the IMS AS.

In some examples, when the IMS AS identifying information is the SIP URI or IMS AS diameter address, the consumer network function may connect to the IMS AS based on the SIP URI/diameter address. This is shown by step 620 in FIG. 6.

In some examples, when there IMS identifying information is the IMS AS instance identifier or IMS AS set identifier, then at 616 the consumer network function may send, to the NRF, a third message. The third message may comprise a further discovery request indicating the IMS AS instance identifier or IMS AS set identifier. In some example embodiments, the further discovery request may comprise one or more of the one or more IMS AS parameters described above in relation to step 600.

At 618, the NRF sends, to the consumer network function, a response comprising an address of the IMS AS (e.g., an IP address) based on the third message. For example, the NRF may determine the IMS AS address from the stored NF profile of the IMS AS based on the IMS AS instance/set identifier in the request.

At 620 the consumer network function connects to the IMS AS based on the IMS AS address (either in the IMS AS identifying information received from the HSS 403 or UDM 106 at 614 or in the response received from the NRF at 618).

Examples have been described in which IMS AS discovery and service exposure is enabled (or otherwise facilitated) via the HSS or UDM. In some examples, the HSS or UDM stores an IMS profile of the IMS AS and provides information to a consumer network function to enable (or otherwise facilitate) the consumer network function to discover an IMS AS with particular characteristics (e.g., an IMS AS providing particular IMS services, providing IMS services to certain users, etc.) and connect to the discovered IMS AS. This may be beneficial as user-specific information may already be available to the HSS or UDM, whereas user-specific information may not be available at other network functions (e.g., the NRF may store service-specific information). As such, user-specific IMS AS discovery may be performed via the HSS or UDM with minimal impact on existing network functions.

In some examples, there is provided an apparatus comprising means for providing a home subscriber server or unified data management function configured to perform receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs; storing the received one or more IMS profiles; receiving, from a consumer network function, a second message comprising a discovery request indicating a target network function type as IMS AS and one or more target parameters; and sending, to the consumer network function, an IMS profile comprising one or more parameters matching the one or more target parameters.

In some examples, there is provided an apparatus comprising at least one processor and at least one memory storing instructions that, when executed by the at least one processor, cause the apparatus at least to: receive one or more internet protocol multimedia subsystem, IMS, profiles from one or more IMS application servers, IMS ASs, each IMS profile comprising IMS AS identifying information and one or more parameters of a respective IMS AS of the one or more IMS ASs; store the received one or more IMS profiles; receive, from a consumer network function, a second message comprising a discovery request indicating a target network function type as IMS AS and one or more target parameters; and send, to the consumer network function, an IMS profile comprising one or more parameters matching the one or more target parameters.

In some examples, there is provided an apparatus comprising means for providing a consumer network function configured to perform: sending, to a home subscriber server or unified data management function, a second message comprising a discovery request indicating a target network function type as internet protocol multimedia subsystem application server, IMS AS, and one or more filter parameters defining one or more target parameters; receiving, from the home subscriber server or unified data management function, an IMS profile based on the one or more filter parameters; and connecting to the IMS AS based on the received IMS profile.

In some examples, there is provided an apparatus comprising at least one processor and at least one memory storing instructions that, when executed by the at least one processor, cause the apparatus at least to: send, to a home subscriber server or unified data management function, a second message comprising a discovery request indicating a target network function type as internet protocol multimedia subsystem application server, IMS AS, and one or more filter parameters defining one or more target parameters; receive, from the home subscriber server or unified data management function, an IMS profile based on the one or more filter parameters; and connect to the IMS AS based on the received IMS profile.

In some examples, there is provided an apparatus comprising means for providing an internet protocol multimedia subsystem application server, IMS AS, configured to perform: providing IMS services to one or more users or one or more groups of users; and sending, to a home subscriber server or unified data management function, a first message comprising an IMS profile of the IMS AS.

In some examples, there is provided an apparatus comprising at least one processor and at least one memory storing instructions that, when executed by the at least one processor, cause the apparatus at least to: provide IMS services to one or more users or one or more groups of users; and send, to a home subscriber server or unified data management function, a first message comprising an IMS profile of the IMS AS.

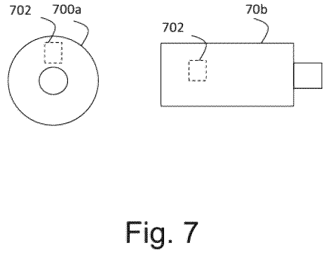

FIG. 7 shows a schematic representation of non-volatile memory media 700a (e.g., computer disc (CD) or digital versatile disc (DVD)) and 700b (e.g. universal serial bus (USB) memory stick) storing instructions and/or parameters 702 which when executed by a processor allow the processor to perform one or more of the steps of the method of FIG. 5.

It is understood that references in the above to various network functions (e.g., to an AMF, an SMF, a TNF, etc.), an apparatus may be configured to operate as one or more of the network functions. In some examples, an apparatus may be configured to perform at least some of the functionality associated with an AMF, an SMF, and/or a TNF. In some examples, an apparatus may comprise a virtual network function instance of an AMF, an SMF, and/or a TNF.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above, by way of non-limiting and illustrative example, with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting and illustrative examples, hardware, software, firmware, special purpose circuits or logic, general purpose hardware or controller or other computing devices, or some combination thereof.

As used herein, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the FIGs. may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Various example embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the disclosure is set out by the independent claims. The example embodiments and features thereof, if any, described in this disclosure that do not fall under the scope of the independent claims are to be interpreted as examples useful for understanding various example embodiments of the disclosure.

The foregoing description has provided, by way of non-limiting and illustrative examples, a full and informative description of the various example embodiments of this disclosure. However, various modifications and adaptations may become apparent to those skilled in the relevant arts in view of the foregoing description, when read in conjunction with the accompanying drawings and the claims. However, all such and similar modifications of the teachings will still fall within the various example embodiments of the disclosure as set forth in the claims. By way of non-limiting and illustrative example, there is a further example embodiment comprising a combination of one or more example embodiments with any of the other example embodiments previously discussed.

We claim:

1. An apparatus comprising: at least one processor; and at least one memory storing instructions that, when executed by the at least one processor, cause the apparatus at least to perform:
receiving one or more internet protocol multimedia subsystem, IMS, profiles from one or more IMS application servers, IMS ASs, each IMS profile comprising IMS AS identifying information and one or more parameters of a respective IMS AS of the one or more IMS ASs;
storing the received one or more IMS profiles;
receiving, from a consumer network function, a second message comprising a discovery request indicating a target network function type as IMS AS and one or more target parameters; and
sending, to the consumer network function, an IMS profile comprising one or more parameters matching the one or more target parameters.

2. The apparatus of claim 1, wherein the one or more parameters comprise at least one of the following:
information indicating one or more IMS services provided by the IMS AS;
information indicating one or more users for which the IMS AS supports IMS services;
information indicating one or more groups of users for which the IMS AS supports IMS services;
information indicating one or more user categories for which the IMS AS supports IMS services; or
information indicating one or more events and services that can be exposed by the IMS AS.

3. The apparatus of claim 1, wherein the IMS AS identifying information comprises at least one of the following:
an IMS AS instance identifier or IMS AS set identifier;
a session initiation protocol uniform resource identifier via which the IMS AS can be reached; or
an IMS AS diameter address of the IMS AS.

4. The apparatus of claim 1, wherein the one or more IMS profiles are stored at the home subscriber server or unified data management function and associated to one or more user identifiers.

5. The apparatus of claim 1, wherein the one or more target parameters comprises at least one of the following:
information indicating one or more target IMS services provided by an IMS AS;
information indicating one or more target users for which an IMS AS supports IMS services;
information indicating one or more target groups of users for which an IMS AS supports IMS services; or
information indicating one or more target events and services exposed by an IMS AS.

6. The apparatus of claim 1, wherein the first message and/or second message comprises one of: a diameter protocol message or a service based interface message.

7. The apparatus of claim 6, wherein the first message is a diameter protocol message and comprises a profile update request or a server assignment request.

8. The apparatus of claim 1, wherein the apparatus is further caused to perform:
determining that no IMS profile comprising one or more parameters matching the one or more target parameters is stored at the home subscriber server or unified data management function;
creating a subscription associated with the consumer network function based on the one or more target parameters;
receiving a further IMS profile from an IMS AS, wherein the further IMS profile comprises one or more parameters matching the one or more target parameters; and
sending a notification message to the consumer network function including the IMS profile comprising one or more parameters matching the one or more target parameters.

9. An apparatus comprising: at least one processor; and at least one memory storing instructions that, when executed by the at least one processor, cause the apparatus at least to perform:
sending, to a home subscriber server or unified data management function, a second message comprising a discovery request indicating a target network function type as internet protocol multimedia subsystem application server, IMS AS, and one or more filter parameters defining one or more target parameters;
receiving, from the home subscriber server or unified data management function, an IMS profile based on the one or more filter parameters; and
connecting to the IMS AS based on the received IMS profile.

10. The apparatus of claim 9, wherein the one or more target parameters comprises at least one of the following:
information indicating one or more target IMS services provided by an IMS AS;
information indicating one or more target users for which an IMS AS supports IMS services;
information indicating one or more target groups of users for which an IMS AS supports IMS services;
or
information indicating one or more target events and services exposed by an IMS AS.

11. The apparatus of claim 9, wherein the received IMS profile comprises at least one of the following:
IMS AS identifying information;
information indicating one or more IMS services provided by the IMS AS;
information indicating one or more users for which the IMS AS supports IMS services;
information indicating one or more groups of users for which the IMS AS supports IMS services;
information indicating one or more user categories for which the IMS AS supports IMS services; and
information indicating one or more events and services exposed by the IMS AS.

12. The apparatus of claim 11, wherein the IMS AS identifying information comprises at least one of the following:
an IMS AS instance identifier or IMS AS set identifier;
a session initiation protocol uniform resource identifier via which the IMS AS can be reached; or
an IMS AS diameter address of the IMS AS.

13. The apparatus of claim 12, wherein the IMS AS identifying information comprises the IMS AS instance identifier or the IMS AS set identifier, and wherein the apparatus is further caused to perform:
sending, to a network repository function, a third message comprising a further discovery request indicating the IMS AS instance identifier or IMS AS set identifier;
receiving, from the network repository function, an IMS AS address based on the third message; and
connecting to the IMS AS based on the received IMS AS address.

14. The apparatus of claim 13, wherein the further discovery request further comprises at least one of the following:
an indication that service exposure via a network exposure function is supported;
information indicating the supported capabilities of the IMS AS;
information identifying one or more users of the IMS AS;
information identifying one or more groups of users of the IMS AS; or
information indicating one or more user categories supported by the IMS AS.

15. An apparatus comprising: at least one processor; and at least one memory storing instructions that, when executed by the at least one processor, cause the apparatus at least to perform:
providing IMS services to one or more users or one or more groups of users; and
sending, to a home subscriber server or unified data management function, a first message comprising an IMS profile of the IMS AS.

16. The apparatus of claim 15, wherein the first message comprises one of: a diameter protocol message or a service based interface message.

17. The apparatus of claim 16, wherein the diameter protocol message comprises a profile update request or a server assignment request.

18. The apparatus of claim 16, wherein the IMS profile comprises at least one of the following:
IMS AS identifying information;
information indicating one or more IMS services provided by the IMS AS;
information indicating one or more users for which the IMS AS supports IMS services;
information indicating one or more groups of users for which the IMS AS supports IMS services;
information indicating one or more user categories for which the IMS AS supports IMS services; or
information indicating one or more events and services exposed by the IMS AS.

19. The apparatus of claim 18, wherein the IMS AS identifying information comprises at least one of the following:
an IMS AS instance identifier or IMS AS set identifier;
a session initiation protocol uniform resource identifier via which the IMS AS can be reached; or
an IMS AS diameter address of the IMS AS.

20. The apparatus of claim 16, wherein the apparatus is further caused to perform:
sending, to a network repository function, a registration message comprising at least one of the following:
information indicating whether the IMS AS supports service exposure via a network exposure function;
information indicating one or more IMS services provided by the IMS AS;
information indicating one or more users for which the IMS AS supports IMS services;
information indicating one or more groups of users for which the IMS AS supports IMS services;
information indicating one or more user categories for which the IMS AS supports IMS services; or
information indicating one or more events and services exposed by the IMS AS.
